(19) United States
(12) Patent Application Publication
(10) Pub. No.: US 2006/0207717 A1
(43) Pub. Date: Sep. 21, 2006

(54) Magnetic wick-clip holder and wick-clip inserter and method employing same

(76) Inventor: Bruce Campbell, Mattituck, NY (US)

Correspondence Address: Galgano & Burke, Suite 35, 300 Rabro Drive, Hauppauge, NY, 11788, US

(21) Appl. No.: 11/083,374

(22) Filed: Mar. 18, 2005

(51) Int. Cl. B32B 37/00

(52) U.S. Cl. 156/293; 156/423

(57) ABSTRACT

A wick-clip inserter includes a movable assembly adapted to move a jar from a first position to a second position, a glue dispenser located at the first position, and a magnetic wick clip holder located at the second position. Preferably, the wick-clip holder is elongated and has a longitudinal groove open to one side thereof via flared sidewalls with the groove having a half round cross-section, and a tapered lower end and a magnet in the tapered end. The wick-clip holder is movable up and down, spring loaded, and has a magnetic attraction strength which is insufficient to overcome the attractive strength of the glue. A method for inserting a wick-clip into a candle jar is also disclosed.

### RELATED APPLICATIONS

This application is related to Applicant's concurrently filed three applications entitled “WICK-CLIP INSERTER FOR CANDLE JARS AND METHOD EMPLOYING SAME” (1440-10), “METHOD FOR LOCATING A CANDLE JAR BELOW A WICK-CLIP INSERTER” (1440-12), and “WICK-CLIP INSERTER WITH ADJUSTMENT MEANS FOR DIFFERENT CANDLE JAR SIZES” (1440-13).

### BACKGROUND OF THE INVENTION

1. Field of the Invention

This invention relates broadly to candle making. More particularly, this invention relates to an apparatus and method for the insertion of wick-clips into candle containers.

2. State of the Art

Candles are popular aesthetic accessories for many occasions. A popular type of candle is the “jar candle” which is a wax candle housed in a glass jar typically one to four inches in diameter. Jar candles have several advantages. The chief advantage of a jar candle is that the wax is contained so that it will not drip onto the surface of furniture when the candle is burning.

Jar candles are manufactured by inserting a wick-clip into a container and gluing it to the bottom of the container, then filling the container with hot wax. The term “wick-clip” is a term of art which means a candle wick with a small metal disk (clip) attached to one end. Wick-clips and methods of making them are described in co-owned U.S. Pat. No. 6,532,649 and patents cited therein.

Prior art FIG. 19 illustrates a jar 1 with a wick-clip 2 installed. The wick-clip 2 includes a wick 3 and an eyelet (or clip) 4. The eyelet 4 is a disk 5 with a cylinder 6 extending up from its center. It is attached to the wick by inserting the wick 3 into the cylinder 6 and crimping the cylinder 6.

Most manufacturers of jar candles operate in a fully manual process. A worker manually glues a wick-clip to the bottom of a container and then pours in molten wax. This process has several disadvantages. First, it is labor intensive, thereby increasing the cost of the candles and/or forcing the manufacturer to move operations to countries where labor is less expensive.

Second, it is very difficult to manually place the wick-clip in the exact center of the jar, thereby resulting in an aesthetically imperfect candle. An off center wick will overheat one side of the candle and leave unmelted solid wax on the other side. This shortens burn time since all the wax is not melted and utilized as fuel. If wax is left unconsumed in the container, the consumer feels cheated that they didn't get their full value for the money spent. Perceived value for the product diminishes. The hot side can accumulate soot since the exhaust emissions from the flame may directly impact on the container wall. Black soot deposits will detrimentally affect consumer perception, and adversely affect repeat purchases. Too much heat on one side can crack a glass container and/or cause it to shatter spilling hot wax and glass. This is unsafe and can result in injury, fire or death.

Third, manual operations with hot glue and hot wax are dangerous, thereby increasing the chance of worker injury.

Several companies provide automated or semi-automated machinery for candle manufacturers. They have machines that run from semi-automatic to fully automatic. In one commercially available machine, the semi-automatic wick inserter processes one jar at a time in a rotary star wheel. This machine moves one jar at a time under a glue station and deposits a drop of glue. The star wheel is fixed and not adjustable and therefore is inherently sloppy as it cannot accommodate small dimensional variations in the jars. This means glue centering is not precise and the wick may be off center. The machine also requires change over parts to accommodate different diameter jars. Changeovers are cumbersome, time consuming and inherently imprecise.

After depositing a drop of glue, the semi-automatic machine rotates the container and stations further where an operator manually inserts a wick-clip assembly. If the glue drop were properly centered, it would help the operator find the center of the container. However, because of the dimensional intolerance of the star wheel, the glue drop is often off center.

The fully automatic wick crimper/inserters have all the same sloppiness, inaccuracies, etc. as the semi-automatic machines. The difference is that the wick-clips are created, one at a time, and mechanically inserted into the jar. The mechanical insertion is subject to the same sloppiness as the glue deposition because of the non-adjustable star wheel, so the wicks may or may not be on center. Another downside of this design (which is common to all the other machines in this field) is that the entire process is dependent on the successful production of wick-clips. This means that the automatic wick crimper/inserter, and all other similar machines experience very frequent downtime that is inherent in wick-clip assembly manufacturing. They have to make the wick-clip assembly first and then insert it. The machines require continuous lengths of waxed wick on wooden reels. If the wick isn't waxed properly or has any imperfections it will jam in the wick-clip assembly making part of the machine and the whole machine will stop. If the metal eyelets (the metal holders at the bottom of the wick-clip assembly) are bent, rusty, oily or get stuck in the vibratory bowl or in the roadway feeding the wick-clip assembly making part of the machine, the whole machine will stop. If the razor blade that cuts the wick to size gets dull and starts to tear the wick, the whole machine will jam and stop. If the crimping tool that crimps the metal eyelet to the waxed wick breaks, gets dull, or isn't adjusted properly, the machine will jam and the whole machine will stop. If any of the mechanical or electrical parts of the wick-clip assembly making part of the machine fail or wear out of tolerance, the whole machine will stop. The manufacturing of wick-clips is a difficult process and is generally associated with a significant amount of downtime due to the fragility of the waxed wick and the thin metal eyelets, as well as the engineering and design of the machinery that is necessary to manufacture wick-clips. Combining wick-clip assembly and insertion in the same machine unnecessarily complicates both processes.

The problem with down time on these types of machines is that in many applications these machines are the front end to feeding automated filling lines where the jars with the glued in wick-clips are filled with wax. If the container supply stops, then empty gaps are created on the filling line conveyor which lowers the productivity and efficiency of everything downstream of the automated wick-clip insertion machine. When the candle manufacturing process is tied to a machine that has to make wick-clips in real time, then that machine becomes the bottleneck for production, and productivity suffers.

As jar candle aficionados know, it is not uncommon to place more than one wick in a jar candle. However, none of the wick-clip insertion machines described above have the ability to insert more than one wick-clip at a time.

### SUMMARY OF THE INVENTION

It is therefore an object of the invention to provide methods and apparatus for inserting wick-clips in jars.

It is another object of the invention to provide a wick-clip inserting apparatus which is adaptable to many different size jars without change over parts.

It is a further object of the invention to provide a wick-clip inserting apparatus which is adaptable to minor differences in jar diameters.

It is also an object of the invention to provide a wick-clip inserting apparatus which accurately centers wick-clips in jars.

It is an additional object of the invention to provide a wick-clip inserting apparatus which has a quick setup time.

It is still another object of the invention to provide a wick-clip inserting apparatus which is adaptable to insert a plurality of wick-clips in a single jar.

It is yet another object of the invention to provide a wick-clip inserting apparatus which utilizes pre-manufactured wick-clips.

Certain of the foregoing and related objects are attained by a wick-clip inserter for candle jars comprising a movable assembly adapted to move a plurality of jars from a first position to a second position, a plurality of glue dispensers located at said first position; and a plurality of wick-clip holders at said second position, said wick-clip holders adapted to move up and down, wherein said movable assembly moves said plurality of jars to said first position where said glue dispensers deposit glue in each of said jars, and said movable assembly moves said plurality of jars to said second position where said wick-clip holders move down depositing a wick-clip onto said glue.

Preferably, the movable assembly includes a notched bar and a cross bar, said notched bar having a plurality of notches along a side thereof facing said cross bar for at least partial receipt of a jar in each of said notches. The notches are desirably generally V-shaped.

Most advantageously, the wick-clip inserter further comprises means for aligning the jars under said wick-clip holders and which preferably includes a plate having center markers in vertical alignment with, and disposed below, said wick-clip holders and adjustment means for adjusting, according to jar size, the position of said notched bar relative to said movable assembly.

Most desirably, the plurality of glue dispenser and wick-clip holder is four, said wick-clip holders are magnetic and spring loaded. In a preferred embodiment, said wick-clip holders are elongated and generally finger-shaped and are disposed in a generally upright position with a flared longitudinal groove open to one side thereof. Each have a tapered lower end and a magnet in said tapered end. In a particularly preferred embodiment, the wick-clip inserter further comprises an openable, substantially transparent housing in which said movable assembly and plurality of glue dispensers and wick-clip holders are housed.

Most advantageously, at least one first cylinder is coupled to said movable assembly for effecting movement of said movable assembly between said first and second positions, at least one second cylinder is coupled to said wick-clip holders, and automatic control means is coupled to said first and second cylinders and said glue dispensers for causing said first cylinder to move said movable assembly to said first location, causing said glue dispenser to dispense glue, causing said first cylinder to move said movable assembly to said second location, and causing said second cylinder to move said wick-clip holder down into said inserted position relative to a jar. Preferably, said at least one first cylinder causes generally horizontal reciprocal movement of said movable assembly, and said at least one second cylinder causes generally vertical reciprocal movement of said wick-clip holders.

Certain of the foregoing and related objects are also attained according to the present invention by a method for inserting wick-clips into candle jars, comprising the steps of
(a) arranging a plurality of glue dispensers at a first position;
(b) arranging a plurality of wick-clip holders at a second position;
(c) placing a plurality of candle jars in a movable assembly;
(d) moving said movable assembly to said first position;
(e) dispensing glue from said glue dispensers into each of said jars;
(f) moving said movable assembly to said second position; and
(g) moving said wick-clip holders down depositing a wick-clip onto the glue in each jar.

Preferably, said step of placing a plurality of candle jars in a movable assembly includes placing the jars between a notched block and a cross bar. Desirably, the method further comprises the step of releasably holding wick-clips in said wick-clip holders magnetically. Advantageously, the method further comprises the step of first aligning the jars under the wick-clip holders at a predetermined alignment and adjusting the movable assembly so that the jars are positioned at a predetermined alignment below the wick-clip holders and glue dispensers. Most advantageously, said step of aligning includes marking the center of the bottom of a jar and aligning it on a plate having center markers below the wick-clip holders and orienting the jar at said predetermined alignment relative to said center markers, i.e., either aligned with the center markers or offset therefrom.

In a preferred embodiment, the method further comprises the steps of before moving said movable assembly to said second position, inserting a wick-clip into each holder, partially rotating said jars and repeating steps (c)-(g) at least once to secure a plurality of wick-clips in each of said jars and performing steps a-g within an openable, substantially transparent housing.

In a further preferred embodiment of the invention, the wick-clip inserter of the present invention includes a stainless steel plate upon which a movable jaw assembly is mounted. The jaw assembly is adjustable, designed to hold four glass jars side by side, and is movable to three positions: open, glue dispensing, and wick-clip insertion. The presently preferred jaws include a V-block and a cross bar. The V-block has four V-cuts, each designed to receive a jar which is pressed against the V-cut by the cross bar. Four glue dispensers and four wick-clip holders are mounted above the steel plate. The glue dispensers are coupled to hot glue machine which is mounted under the steel plate. The wick-clip holders are magnetic, spring loaded, and are movable up and down. The steel plate is marked with four holes, each with four cross-hairs at the four locations directly below the wick-clip holders. The entire apparatus is enclosed in a protective clear plastic housing which has several doors, including a front door through which glass jars are loaded and retrieved. The front door, the jaws, and the wick-clip holders are operable by pneumatic or hydraulic cylinders and the machine cycle is microprocessor controlled.

Prior to operating the machine, a jar is selected and the jaws are adjusted to fit the selected jar size. This is accomplished (for a single wick insertion) by marking the center of the bottom of the jar, locating the jar on the steel plate so that the center marking overlies one of the four holes in the steel plate, and adjusting the jaws so that they grip the jar with its center aligned over the hole. For multiple wick insertions, the jar is marked off center and the jaws adjusted accordingly.

After the jaws are adjusted, operation of the inserter follows the following cycle. An operator places four jars in the V-cuts and places four wick-clips in the wick-clip holders. The machine is activated causing the jaws to close, the front door to close, and the jaws with the jars to move backward until the jars are under the glue dispensers. At this work station, glue is dispensed into the jars and the jaws move the jars forward under the wick-clip holders. At this work station, the wick-clip holders descend into the jars and the eyelet of the wick-clip contacts the glue. The tackiness of the glue is sufficient to overcome the attraction of the magnetic wick-clip holder. The wick-clip holders rise leaving the wick-clips in the jars secured by the glue. The jaws move forward and open and the front door opens. This concludes the cycle. The operator removes the jars with the glued wick-clips and repeats the process.

According to a further embodiment of the invention, a wick-clip inserter includes a movable assembly adapted to move a plurality of jars from a first position to a second position, a plurality of glue dispensers located at said first position; and a plurality of wick-clip holders at said second position, said wick-clip holders adapted to move up and down, wherein said movable assembly moves said plurality of jars to said first position where said glue dispensers deposit glue in each of said jars, said movable assembly moves said plurality of jars to said second position where said wick-clip holders move down depositing a wick-clip onto said glue.

According to another embodiment of the invention, a wick-clip inserter includes a movable assembly adapted to move a jar from a first position to a second position, a glue dispenser located at said first position and coupled to a supply of glue, a wick-clip holder located at said second position, said wick-clip holder being magnetic.

According to another embodiment, a wick-clip inserter includes a glue dispenser at a first location, a wick-clip holder at a second location, a movable assembly movable to said first location and said second location, said movable assembly including a V-block having a V-cut and a cross bar arranged such that a candle jar is held snugly in the movable assembly.

According to another embodiment, a wick-clip inserter includes a plurality of glue dispensers at a first location, a plurality of wick-clip holders at a second location, a movable assembly movable to said first location and said second location, said movable assembly including a V-block having a plurality of V-cuts and a cross bar arranged such that a plurality of candle jars are held snugly in the movable assembly.

A method according to the invention includes arranging a plurality of glue dispensers at a first position, arranging a plurality of wick-clip holders at a second position, placing a plurality of candle jars in a movable assembly, moving said movable assembly to said first position, dispensing glue from said glue dispensers into each of said jars, moving said movable assembly to said second position, and moving said wick-clip holders down depositing a wick-clip onto the glue in each jar.

Another embodiment of a method according to the invention includes arranging a glue dispenser located at a first position, arranging a magnetic wick-clip holder at a second position, inserting a wick-clip into said holder so that it is magnetically held by the holder, moving a candle jar under the glue dispenser, dispensing glue into the jar, moving the jar under the wick-clip holder, and lowering the wick-clip holder into the jar so that the wick-clip contacts the glue.

Another embodiment of a method according to the invention includes marking a plate directly underneath the inserter, marking the center of the bottom of the candle jar; and locating the marking on the jar over the marking on the plate.

Another embodiment of a method according to the invention includes marking the diameter of the bottom of the candle jar, marking an offset mark on the diameter spaced apart from the center of the jar, locating the offset mark over the marking on the plate, inserting a first wick-clip, rotating the jar about its center; and inserting a second wick-clip.

Certain of the foregoing and related objects are readily attained according to the present invention by the provision of a wick-clip inserter comprising a movable assembly adapted to move a jar from a first position to a second position, a glue dispenser located at said first position, and a wick-clip holder located at said second position, said wick-clip holder being magnetic. Preferably, said wick-clip holder is elongated and has a longitudinal groove open to one side thereof via flared sidewalls, said groove has a half round cross-section, and said wick-clip holder has a tapered lower end and a magnet in said tapered end.

Desirably, said wick-clip holder is movable up and down, said wick-clip holder is spring loaded, and said magnetic wick-clip holders has a magnetic attraction strength which is insufficient to overcome the attractive strength of the glue. Advantageously, a plurality of said wick-clip holders are provided.

Certain of the foregoing and related objects are also attained in a method for inserting a wick-clip into a candle jar, comprising the steps of: (a) arranging a glue dispenser located at a first position, (b) arranging a magnetic wick-clip holder at a second position, (c) inserting a wick clip into said holder so that it is magnetically held by the holder, (d) moving a candle jar under the glue dispenser, (e) dispensing glue into the jar, (f) moving the jar under the wick-clip holder, and (g) lowering the wick-clip holder into the jar so that the wick-clip contacts the glue.

In a preferred embodiment, the method further comprises the steps of lifting the magnetic wick-clip holder out of the jar leaving the wick-clip in the jar, partially rotating the jar and repeating steps (c)-(h) to place another wick-clip in said jar; and providing a plurality of glue dispensers and magnetic wick-clip holders and simultaneously performing said steps with a plurality of candle jars.

Certain of the foregoing and related objects are also attained according to the invention by the provision of a magnetic wick-clip holder for a wick-clip inserter comprising an elongated, generally upright housing having a longitudinal groove opening onto a side thereof with a portion of said housing being magnetic. Preferably, the magnetic wick-clip holder for a wick-clip inserter has the features as described above.

Certain of the foregoing and related objects are readily attained according to the present invention by the provision of a method for locating a candle jar below a wick-clip inserter, comprising the steps of: (a) positioning a plate beneath the wick-clip inserter, (b) marking the plate at the spot it is vertically aligned with the wick-clip inserter, (c) marking the center of the bottom of the candle jar, and (d) locating the marking on the jar over the marking on the plate. Preferably, the method includes the additional step of applying an adhesive to the center of the bottom of the candle jar, and depositing a wick-clip in said adhesive.

In a preferred embodiment, the method comprises the steps of: (a) positioning a plate beneath the wick-clip inserter, (b) marking a plate at a spot it is vertically aligned with the wick-clip inserter, (c) marking the diameter of the bottom of the candle jar, (d) marking an offset mark on the bottom of the candle jar on the diameter spaced apart from the center of the jar, (e) locating the offset mark over the marking on the plate, (f) inserting and adhesively depositing a first wick-clip on the bottom of the candle jar at said offset mark, (g) partially rotating the jar about its center; and (h) inserting and adhesively depositing a second wick-clip on the bottom of the candle jar at a position spaced from said first wick-clip.

In a further preferred embodiment, said step of partially rotating comprises rotating approximately 90, 120 or 180 degrees, and inserting an adhesively depositing second, third and/or fourth wick-clip.

Certain of the foregoing and related objects are readily attained according to the present invention by the provision of a wick-clip inserter comprising a plurality of glue dispensers at a first location, a plurality of wick-clip holders at a second location, a movable assembly movable to said first location and said second location, said movable assembly including a notched block having at least one notch along a side thereof, and a cross bar arranged opposite to said notched side of said notched block. The notched block and the cross bar are movable relative to one another between an open and closed position, in the latter of which the candle jars may be held snugly therebetween with a jar at least partially within each notch. Means for adjusting the position of said notched bar and cross bar relative to said movable assembly is also provided, such that when said movable assembly is moved to said first location, the jars held by it are aligned in a predetermined position relative to the vertical axis of the glue dispensers and when said movable assembly is moved to said second location, the jars are aligned in said same predetermined position relative to the vertical axis of the wick-clip holders.

In one embodiment, the predetermined position is defined by the centers of the jars being aligned with the vertical axis of said glue dispensers and said wick-clip inserters. In an alternative embodiment, the centers of the jars are offset relative to the vertical axis of said glue dispensers and said wick-clip inserters.

Preferably, said notched bar has a plurality of notches along a side thereof facing said cross bar for at least partial receipt of a jar in each of said notches. The notches are generally V-shaped and are dimensioned to accept jars of different diameter. Most desirably, the means for adjusting comprises at least one latch handle for locking said notched bar in a fixed position relative to said movable assembly. The wick-clip holders are movable vertically to deposit a wick-clip in a jar.

In a preferred embodiment, at least one first cylinder is coupled to said movable assembly for effecting movement of said movable assembly between said first and second positions, at least one second cylinder is coupled to said wick-clip holders, and automatic control means is coupled to said first and second cylinders and said glue dispensers for causing said first cylinder to move said movable assembly to said first location, causing said glue dispenser to dispense glue, causing said first cylinder to move said movable assembly to said second location, and causing said second cylinder to move said wick-clip holder down into said inserted position relative to a jar. Preferably, said at least one first cylinder causes generally horizontal reciprocal movement of said movable assembly, and said at least one second cylinder causes generally vertical reciprocal movement of said wick-clip holders.

Most desirably, means for aligning the jars under said wick-clip holders are provided. The means for aligning includes a plate having center markers in vertical alignment with, and disposed below, said wick-clip holders.

Additional objects and advantages of the invention will become apparent to those skilled in the art upon reference to the detailed description taken in conjunction with the provided figures.

### BRIEF DESCRIPTION OF THE DRAWINGS

FIG. 1 is a front elevational view of a wick-clip inserter according to the invention;

FIG. 2 is a view similar to FIG. 1 with some parts removed for clarity;

FIG. 3 is a side elevational view of the wick-clip inserter;

FIG. 4 is a view similar to FIG. 3 with some parts removed for clarity;

FIG. 5 is a top view of the wick-clip inserter;

FIG. 6 is a view similar to FIG. 5 with some parts removed for clarity;

FIG. 7 is a top view of the stainless steel plate of the wick-clip inserter;

FIG. 8 is a front elevational view of the wick-clip holder of the wick-clip inserter;

FIG. 9 is a side elevational view of the wick-clip holder;

FIG. 10 is a section taken along line 10-10 in FIG. 8;

FIG. 11 is a perspective view of the wick-clip inserter showing the protective casing and doors;

FIG. 12 is a perspective view of the jaw assembly with four jars with wick-clips installed;

FIG. 13 is a view similar to FIG. 8 showing the magnetic wick-clip holder with a wick-clip;

FIG. 14 is a view similar to FIG. 13 but showing the wick-clip holder depositing a wick-clip onto a spot of glue in a jar;

FIG. 15 is a view similar to FIG. 14 showing the wick-clip holder rising after depositing a wick-clip;

FIG. 16 is a schematic plan view of marking the center and off center of the bottom of a glass jar;

FIG. 17 show steps in the placement of three wicks in a single jar;

FIG. 18 shows steps in the placement of two or four wicks; and

FIG. 19 is a side elevational view of a prior art jar with a wick-clip.

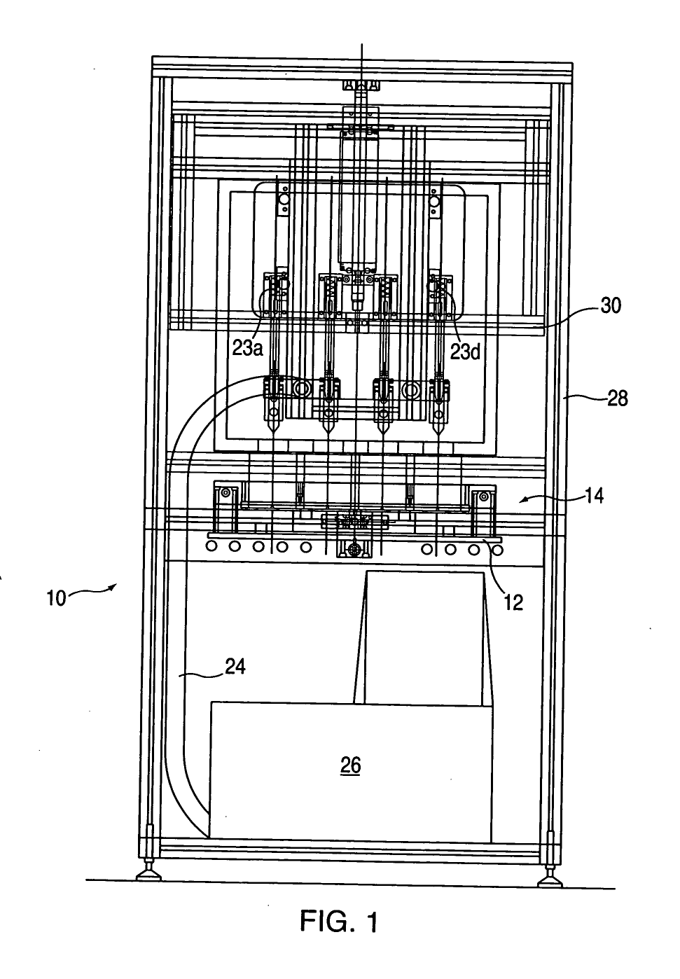

### DETAILED DESCRIPTION OF THE PREFERRED EMBODIMENT

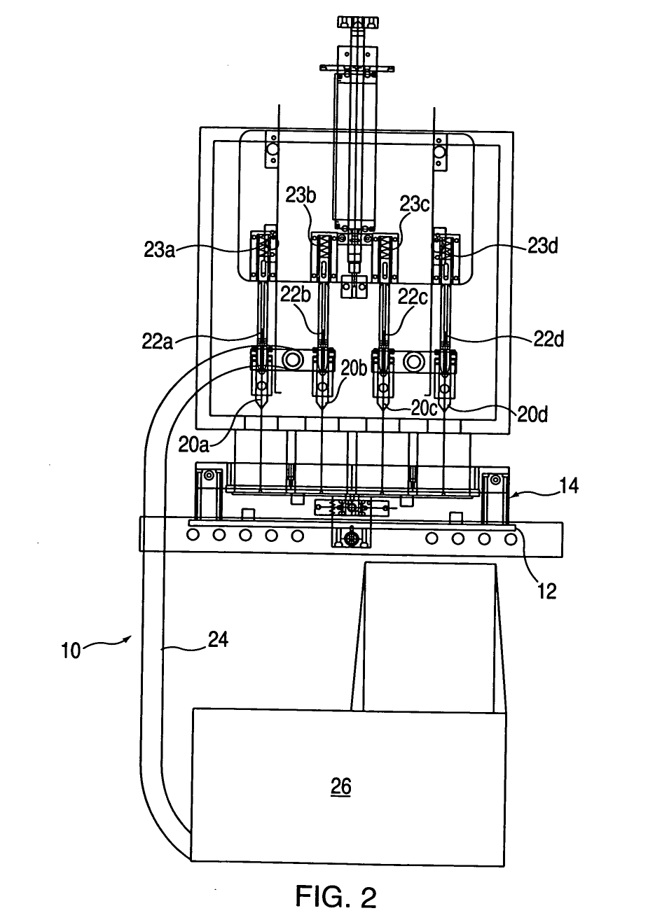

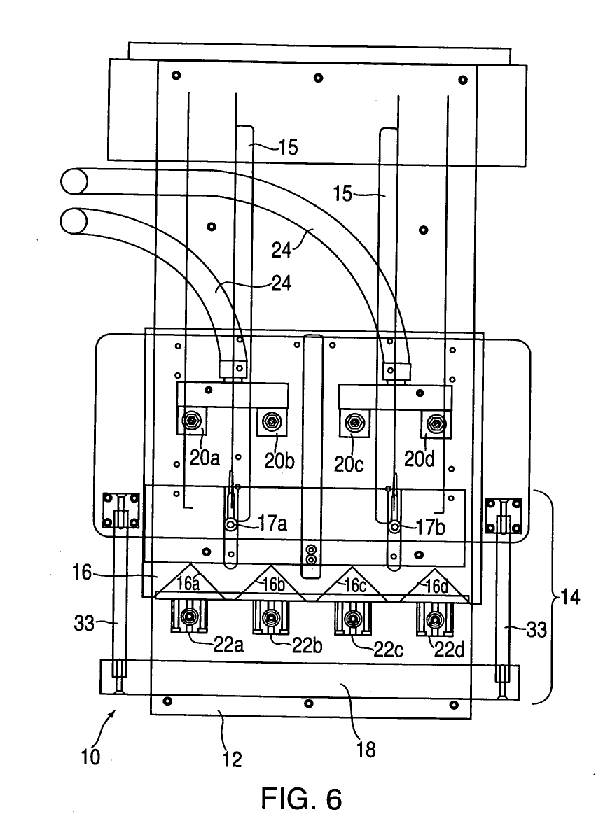

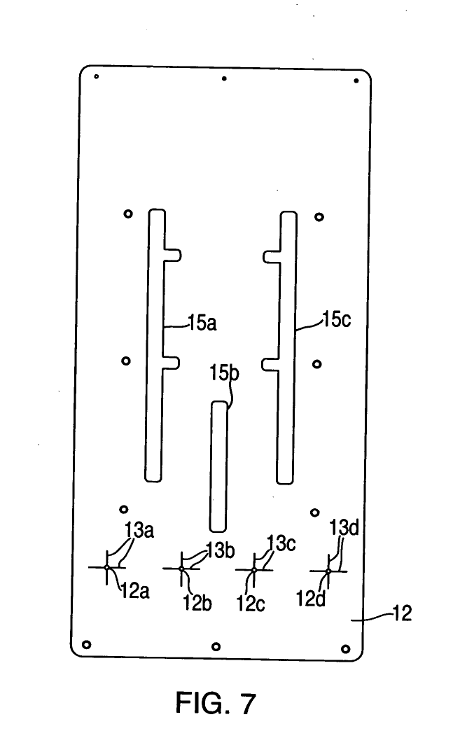

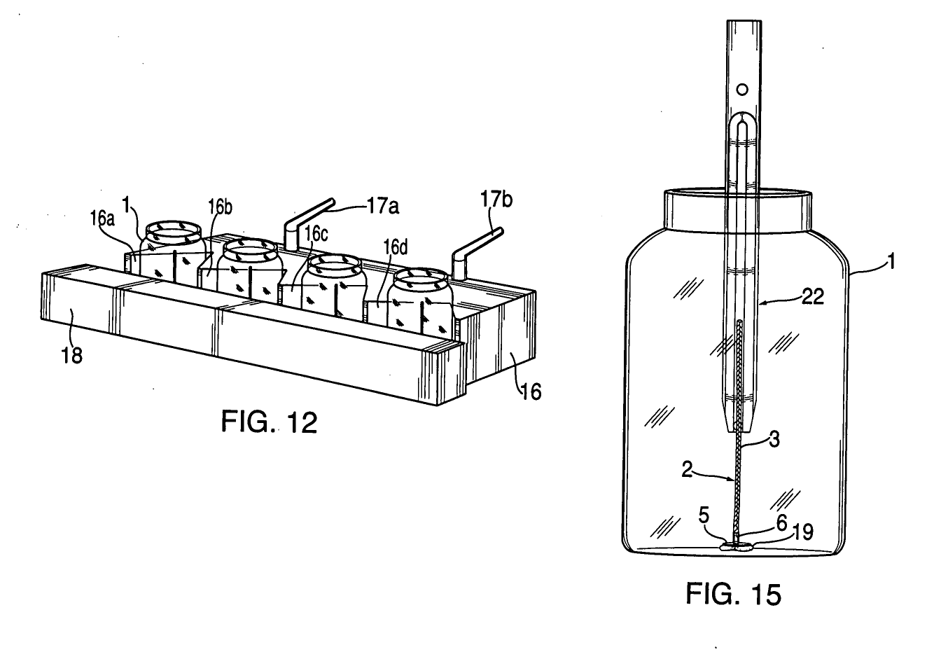

Turning now to the figures generally, a wick-clip inserter 10 according to the invention includes a platform, e.g., stainless steel plate 12, upon which a movable jaw assembly 14 (seen best in FIG. 6) is mounted for horizontally-reciprocal movement on rails 15. The jaw assembly is adjustable, designed to preferably hold four glass jars side by side, and is movable to three positions: open, glue dispensing, and wick-clip insertion. As see best in FIG. 12, the jaw assembly 14 includes a V-block or notched block 16 and a cross bar 18. The V-block 16 has four V-shaped cuts 16a-16d, each designed to receive a jar which is pressed against the V-cut by the cross bar 18. Latches 17a, 17b (seen best in FIGS. 6 and 12) allow the location of the V-block 16 to be adjusted to accommodate different diameter jars. As seen best in FIGS. 2 and 6, four glue dispensers 20a-20d and four wick-clip holders 22a-22d are mounted above the steel plate 12. The glue dispensers are coupled via a conduit 24 to a conventional hot glue machine 26 which is mounted under the steel plate 12. The wick-clip holders 22a-22d are magnetic, spring loaded, and are movable up and down. Springs 23a-23d (seen best in FIG. 2) allow for variations in the thickness of jar bottoms. The steel plate 12 (shown alone in FIG. 7) is marked with four holes 12a-12d, each with four cross-hairs 13a-13d at the four locations directly below the wick-clip holders 22a-22d. Slots 15a-15c are provided for sliding movement of the entire jaw assembly 14.

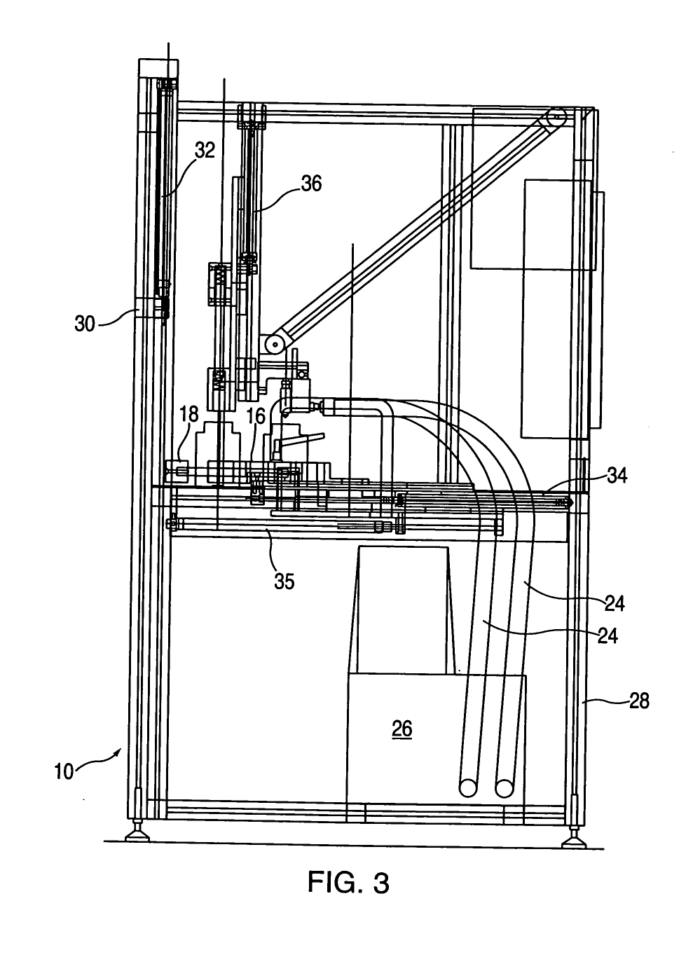

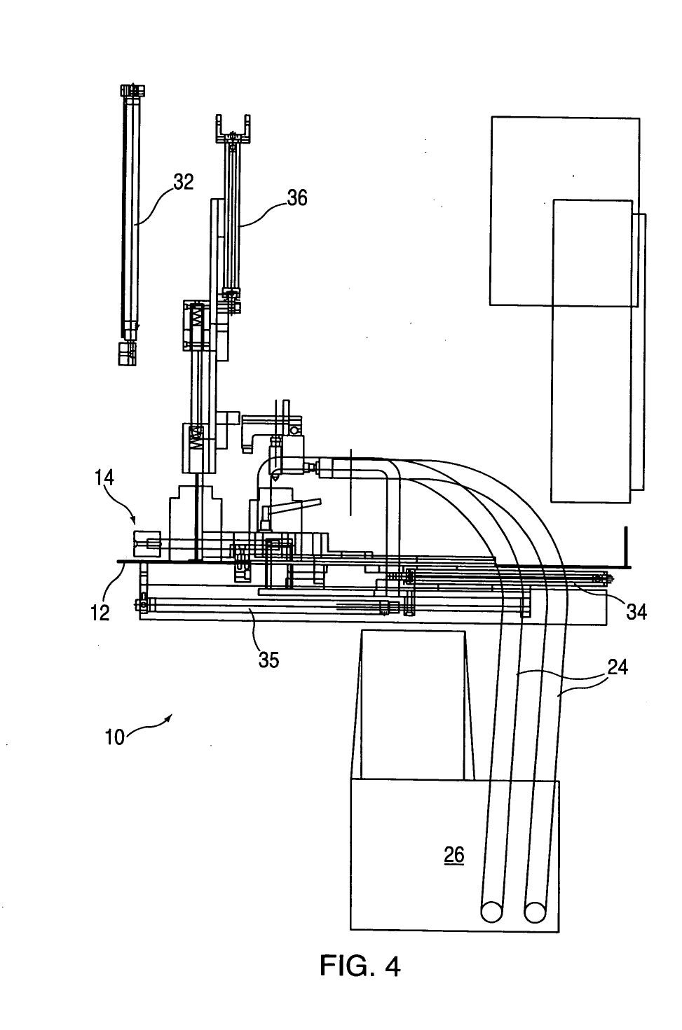

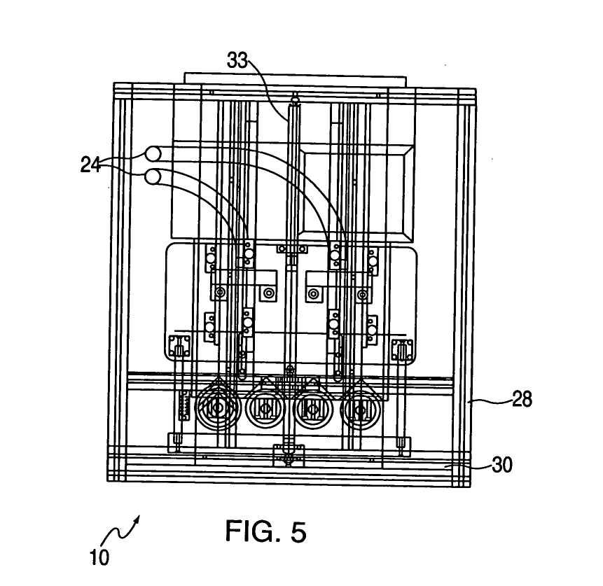

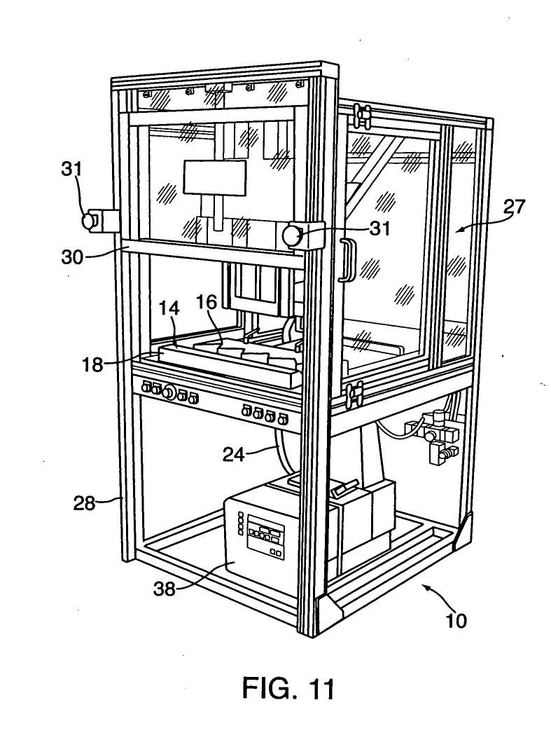

As seen best in FIG. 11, the entire apparatus is enclosed in a protective clear plastic housing 27 mounted in an aluminum frame 28 which has several doors, including a front door 30 through which glass jars are loaded and retrieved. The front door 30, the jaws 14, and the wick-clip holders 22a-22d are operable by pneumatic or hydraulic cylinders 32, 34-35, and 36, respectively (seen best in FIGS. 3 and 4) and the opening and closing of the cross-bar 18 relative to V-block 16 is controlled by pneumatic or hydraulic cylinders 33 (FIGS. 5 and 6). The machine cycle is controlled by a conventional, microprocessor-controlled control unit 38 (FIG. 11) which is activated by push buttons 31.

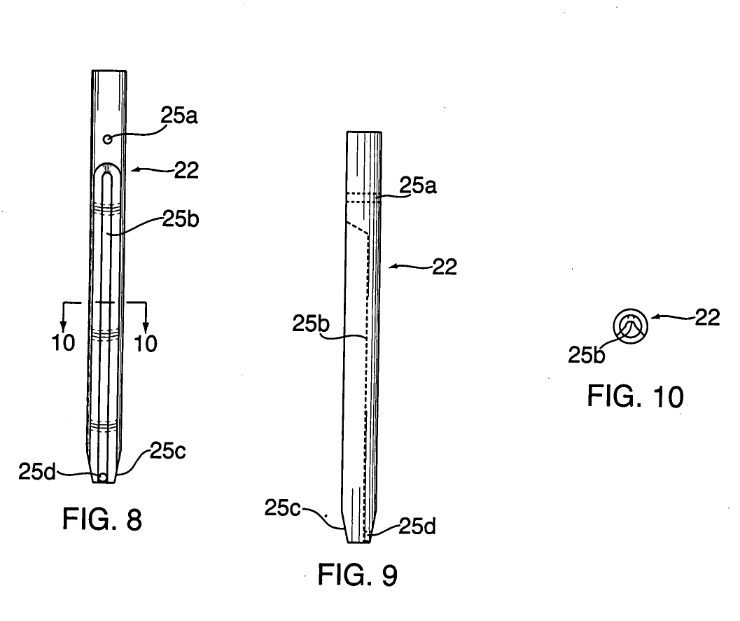

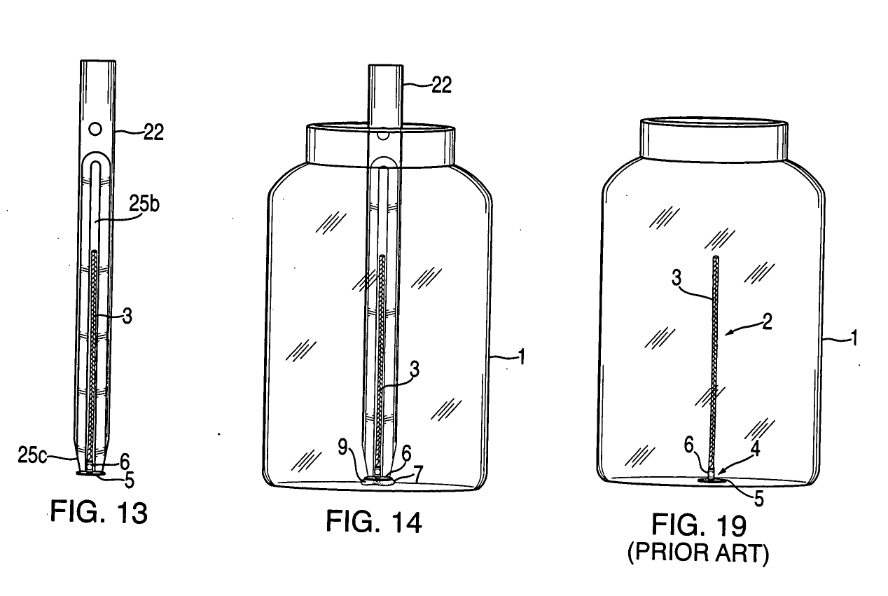

FIGS. 8-10 and 13-15 illustrate details of the magnetic wick-clip holder 22. The generally finger or pen-shaped, elongated holder is generally cylindrical or tubular-shaped and has an upper mounting hole 25a by which it is mounted for vertical reciprocal movement, a longitudinally extending groove 25b, a tapered tip 25c and a hole in its tapered tip 25c in which a magnet 25d is inserted which serves to magnetically hold the wick-clip in groove 25a of holder 22 as shown in FIGS. 13 and 14. The groove 25b preferably has a half-round or semicircular cross-section and is preferably formed with a 90 degree flare as seen best in FIG. 10 to allow for easy and facile insertion of the wick-clip 4. The tapered tip 25c has an overall diameter that is preferably smaller than the diameter of the eyelet 7 of the wick-clip 4 so as to avoid contacting the tip with glue.

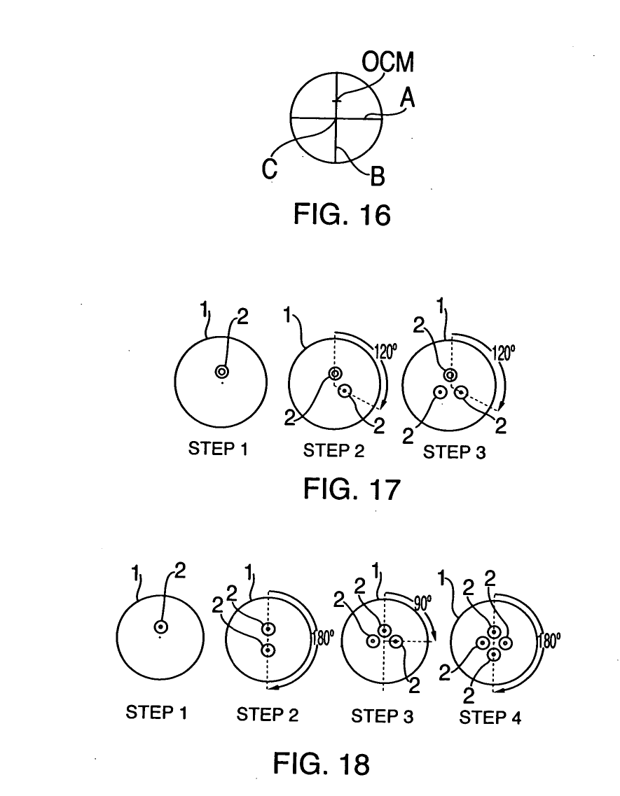

Referring now to FIG. 6, prior to operating the machine, a jar is selected and the jaws 14 are adjusted to fit the selected jar size. This is accomplished (for a single wick insertion) by marking the center of the bottom of a selected jar (for example as shown by A and B in FIG. 16), locating the jar on the steel plate 12 so that the center marking overlies one of the four holes 12a-12d in the steel plate, and adjusting the jaws 14 so that they grip the jar with its center aligned over one of the holes 12a-12d. That is, the latches 17a, 17b are opened to permit V-block 16 to be moved so that one of the V-cuts 16a-16d embraces the jar. The latches are then locked. For multiple wick insertions, the jar is marked off center and the jaws adjusted accordingly. This latched or locked position of the V-block 16, defines the position of the V-block 16 relative to the movable jaw assembly 14 and in turn, the predetermined alignment position of the jars when moved under the wick-clip holders 22a-22d or the glue dispensers 20a-20d, i.e., either the center mark of the jars or the desired off center mark of the jars, are aligned with the glue nozzles or wick-clip holders, thereby assuring an accurate positioning of the wick-clips within the jars in the desired arrangement.

After the jaws are adjusted, operation of the inserter follows the following cycle. An operator places four jars in the V-cuts 16a-16d and places four wick-clips in the wick-clip holders 22a-22d. A wick-clip is shown in a wick-clip holder in FIG. 14. The wick 3 lies in the groove 25b and the metal disk 5 and cylinder 6 of the eyelet are magnetically held in the tapered tip 25c via magnet 25d. It will be noted that the diameter of the disk 5 is slightly larger than that of the tip 25c. The machine is activated by manually depressing push buttons 31 (FIG. 11) which initiates the automatic machine cycle causing the front door 30 to close, the jaws 14 to close, and the jaws 14 with the jars 1 to move backward on the steel plate 12 until the jars are under the glue dispensers 20a-20d. Glue is dispensed into the jars via a nozzle which deposits a dab or drop of glue 9 on the bottom of the jar. As the glue nozzles are fixed in position and spaced above the jars 1, the drops of glue will fall by gravity to the desired spot on the bottom wall of jar. The protective housing 27 shields the drops from wind currents so as to ensure that they drop straight down and are accurately positioned on the bottom wall of the jar.

The jaws 14 then move the jars forward under the wick-clip holders 22a-22d. The wick-clip holders 22 descend into the jars and the eyelet 5 of the wick-clip 2 contacts the glue. FIG. 14 illustrates a wick-clip holder 22 in a jar 1 depositing a wick-clip onto a spot of glue 7. It will be noted that the disk 6 of the eyelet contacts the glue 7 and the glue 7 does not contact the wick-clip holder 22. The tackiness of the glue is sufficient to overcome the attraction of the magnet 25d of magnetic wick-clip holder. The wick-clip holders 22a-22d rise leaving the wick-clips 2 in the jars 1 secured by the glue as shown in FIG. 15. The jaws 14 move forward and open, and the front door 30 then opens. This concludes the cycle. The operator removes the jars with the glued wick-clips and repeats the process.

If the jars have been marked for multiple wick-clip insertions, they are rotated after the first wick is inserted, e.g., by 90 or 180 degrees, and the process is repeated for insertion of the second wick. If a third and fourth wick-clip is to be inserted, the jars are rotated and the process is repeated two more times.

FIG. 16 shows a jar marked for multiple wick-clip insertions. After finding the center C with lines A and B, an off center mark OCM is made. The jar is placed in this predetermined alignment, i.e., with the off center mark OCM directly overlying the hole 25. A first off center wick-clip 2 is inserted in jar 1 as shown at step 1 in FIG. 17. The jar 1 is rotated 120 degrees and a second off center wick-clip 2 is inserted as shown at step 2 in FIG. 17. The jar is rotated another 120 degrees and a third off center wick-clip 2 is inserted as shown at step 3 in FIG. 17. For two or four wicks, the steps shown in FIG. 18 are followed. A first off center wick-clip 2 is inserted as shown at step 1 in FIG. 18. The jar is rotated 180 degrees and a second off center wick-clip 2 is inserted as shown at step 2 in FIG. 18. If only two wicks are desired, the process is complete at step 2. If four wicks are desired, the jar 1 is rotated another 90 degrees and a third off center wick-clip 2 is inserted as shown at step 3 in FIG. 18. The jar 1 is then rotated 180 degrees and a fourth off center wick-clip 2 is inserted as shown at step 4 in FIG. 18.

According to the presently preferred embodiment, all of the doors in the housing 28 are provided with magnetic interlocks so that the machine will shut down if a door is opened during operation. Also according to the presently preferred embodiment, the V-cuts are dimensioned to accept jars having diameters of from about one inch to about four and one half inches and the glue dispensers and wick-clip holders are located to accept jars up to six and one eighth inches tall. The spring loading on the clip holders accommodates up to five eighths of an inch bottom glass thickness.

There have been described and illustrated herein a wick-clip inserter and methods for its use. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

For example, while the apparatus is specifically designed to handle four candle containers at a time, the number can be increased or decrease as desired to fit the desired application. In addition, although the wick-clip inserter has been shown to add up to four wick-clips per jar, the number could be increased if desired. Furthermore, while the movable parts are preferably hydraulically pneumatically activated, other drive mechanism (e.g., gear/pully motor drive assemblies) could be possibly employed. Moreover, the dimensions of the apparatus can be modified to suit differently dimensioned jars. Furthermore, although the location of the glue dispensers and the wick clip holder work stations has been found to be particularly efficient, it may be possible to reverse or modify their position to suit a particular application. Accordingly, other variations may be made as will be apparent to those skilled in the art.

What is claimed:

1. A wick-clip inserter comprising:
a movable assembly adapted to move a jar from a first position to a second position;
a glue dispenser located at said first position; and
a wick clip holder located at said second position, said wick clip holder being magnetic.

2. A wick-clip inserter according to claim 1, wherein:
said wick-clip holder is elongated and has a longitudinal groove open to one side thereof via flared sidewalls.

3. A wick-clip inserter according to claim 2, wherein said groove has a half round cross-section.

4. A wick-clip inserter according to claim 1, wherein:
said wick-clip holder has a tapered lower end and a magnet in said tapered end.

5. A wick-clip inserter according to claim 1, wherein:
said wick-clip holder is movable up and down.

6. A wick-clip inserter according to claim 4, wherein:
said wick-clip holder is spring loaded.

7. A wick-clip inserter according to claim 5, wherein:
said magnetic wick-clip holder has a magnetic attraction strength which is insufficient to overcome the attractive strength of the glue.

8. A wick-clip as provided according to claim 1, wherein a plurality of said wick-clip holders are provided.

9. A method for inserting a wick-clip into a candle jar, comprising the steps of:
(a) arranging a glue dispenser located at a first position;
(b) arranging a magnetic wick-clip holder at a second position;
(c) inserting a wick clip into said holder so that it is magnetically held by the holder;
(d) moving a candle jar under the glue dispenser;
(e) dispensing glue into the jar;
(f) moving the jar under the wick-clip holder; and
(g) lowering the wick-clip holder into the jar so that the wick-clip contacts the glue.

10. A method according to claim 9, further comprising the step of:
(h) lifting the magnetic wick-clip holder out of the jar leaving the wick-clip in the jar.

11. A method according to claim 10, further comprising the step of:
partially rotating the jar and repeating steps (c)-(h) to place another wick-clip in said jar.

12. A method according to claim 11, further comprising the step of:
providing a plurality of glue dispensers and magnetic wick-clip holders and simultaneously performing said steps with a plurality of candle jars.

13. A magnetic wick-clip holder for a wick-clip inserter comprising an elongated, generally upright housing having a longitudinal groove opening onto a side thereof with a portion of said housing being magnetic.

14. A magnetic wick-clip holder for a wick-clip inserter according to claim 13,
wherein said housing has a pair of flared sidewalls merging with said groove.

15. A magnetic wick-clip holder for a wick-clip inserter according to claim 13, wherein said groove has a half round cross section.

16. A magnetic wick-clip holder for a wick-clip inserter according to claim 13, wherein said wick-clip holder has a tapered lower end and a magnet in said tapered end.

17. A magnetic wick-clip holder for a wick-clip inserter according to claim 13, wherein said wick-clip holder is movable up and down.

18. A magnetic wick-clip holder for a wick-clip inserter according to claim 13, wherein said wick-clip holder is spring loaded.

19. A magnetic wick-clip holder for a wick-clip inserter according to claim 13, wherein said magnetic wick-clip holder has a magnetic attraction strength which is insufficient to overcome the attractive strength of the glue.

20. A magnetic wick-clip holder for a wick-clip inserter according to claim 13, wherein a plurality of said wick-clip holders are provided.
